(19) United States
(12) Patent Application Publication
(10) Pub. No.: US 2024/0332850 A1
(43) Pub. Date: Oct. 3, 2024

(54) Electrical Connector Housing and Electrical Connector

(71) Applicants: Tyco Electronics (Suzhou) Ltd., Suzhou City (CN); Tyco Electronics (Shanghai) Co., Ltd., Shanghai (CN)

(72) Inventors: Kang Zhou, Suzhou (CN); Jun Zong, Shanghai (CN); Tao (Thomson) Dong, Suzhou (CN)

(73) Assignees: Tyco Electronics (Suzhou) Ltd., Suzhou City (CN); Tyco Electronics (Shanghai) Co., Ltd., Shanghai (CN)

(21) Appl. No.: 18/618,403

(22) Filed: Mar. 27, 2024

(30) Foreign Application Priority Data
Mar. 27, 2023 (CN) 202320626781.X

(51) Int. Cl. H01R 13/506; H01R 12/70; H01R 13/639

(52) U.S. Cl. CPC H01R 13/506; H01R 12/7082; H01R 13/639

(57) ABSTRACT

An electrical connector housing includes a first housing part, and a second housing part independent of the first housing part. At least one of the first housing part or the second housing part defines a receiving slot for receiving a plurality of connection terminals and a circuit board. The first housing part and the second housing part are adapted to be assembled together in a sliding manner. An electrical connector is also provided which includes the abovementioned electrical connector housing.

### CROSS-REFERENCE TO RELATED APPLICATION

This application claims the benefit of Chinese Patent Application No. CN 202320626781.X filed on Mar. 27, 2023, in the China National Intellectual Property Administration, the whole disclosure of which is incorporated herein by reference.

### FIELD OF THE INVENTION

Embodiments of the present disclosure generally relate to the technical field of electrical connectors, and in particular, to an electrical connector housing and an electrical connector including the same.

### BACKGROUND

In the applications of existing electrical connectors for flexible printed circuit boards, connection terminals are pre-installed on the flexible printed circuit board to achieve physical and electrical connections between electrical contacts on the flexible printed circuit board and the connection terminals, and to form an assembly of the flexible printed circuit board and the connection terminals. Then, the assembly of the flexible printed circuit board and the connection terminals is inserted into a pocket of a housing of the electrical connector as a whole to form a complete electrical connector for the flexible printed circuit board.

In practice, the physical and electrical connections between the electrical contacts on the flexible printed circuit board and the connection terminals are achieved by crimping. As a result, due to the large number of the connection terminals and the influence of the crimped position, during the process of inserting the assembly of the flexible printed circuit board and the connection terminals into the pocket of the electrical connector housing, the accumulated friction force between elastic sheets of the connection terminals themselves and the pocket of the housing made of plastic is larger. Thus, an insertion force required to fully insert the assembly into the pocket of the electrical connector housing is relatively large. Moreover, the flexible characteristics of the circuit board also make it difficult for the assembly to be inserted into the pocket of the electrical connector housing, further increasing the difficulty of insertion. In addition, the insertion method of the assembly can easily cause damage to copper foils of crimping portions of the connection terminals, which are not visible after insertion and thereby posing a serious quality risk.

Moreover, in the related art, the electrical connector housing has poor tolerance for the adhesive dispensing in the puncturing and crimping region of the flexible circuit board and has strict specification requirements for the thickness of adhesive dispensing. Once this dispensing thickness exceeds the specification requirements, the flexible circuit board will be difficult to be inserted. In addition, in the related art, there is still a problem of inaccurate alignment between the connection terminals and through holes of the housing when the assembly of the flexible printed circuit board and the connection terminals is inserted into the pocket of the electrical connector housing.

### SUMMARY

According to an embodiment of the present disclosure, an electrical connector housing includes a first housing part and a second housing part independent of the first housing part. At least one of the first housing part or the second housing part defines a receiving slot for receiving a plurality of connection terminals and a circuit board. The first housing part and the second housing part are adapted to be assembled together in a sliding manner. An electrical connector is also provided which includes the abovementioned electrical connector housing.

### BRIEF DESCRIPTION OF THE DRAWINGS

The invention will now be described by way of example with reference to the accompanying Figures, of which:

FIG. 1 is a schematic structural view showing an electrical connector housing according to an exemplary embodiment of the present disclosure, wherein a first housing part and a second housing part are separated from each other;

FIG. 2 is a schematic sectional view showing the electrical connector housing according to the exemplary embodiment of the present disclosure, wherein the first housing part and the second housing part are assembled together;

FIG. 3 is a schematic structural view showing the electrical connector according to the exemplary embodiment of the present disclosure, wherein the first housing part and the second housing part of the electrical connector housing are separated from each other, and connection terminals and a circuit board have been placed into a receiving slot;

FIG. 4 is a schematic structural view showing the electrical connector according to the exemplary embodiment of the present disclosure, wherein the first housing part and the second housing part of the electrical connector housing are assembled together, and the connection terminals and the circuit board has been locked in the receiving slot; and

FIG. 5 is a schematic sectional view of the electrical connector shown in FIG. 4.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, an electrical connector housing, includes a first housing part and a second housing part independent of the first housing part. At least one of the first housing part or the second housing part defines a receiving slot for receiving a plurality of connection terminals and a circuit board. The first housing part and the second housing part are assembled together in a sliding manner (e.g., toward, and relative to, each other).

According to another embodiment the present disclosure, an electrical connector includes the abovementioned electrical connector housing, a plurality of connection terminals, and a circuit board. The plurality of connection terminals and the circuit board are connected together, and subsequently placed into the receiving slot of the electrical connector housing.

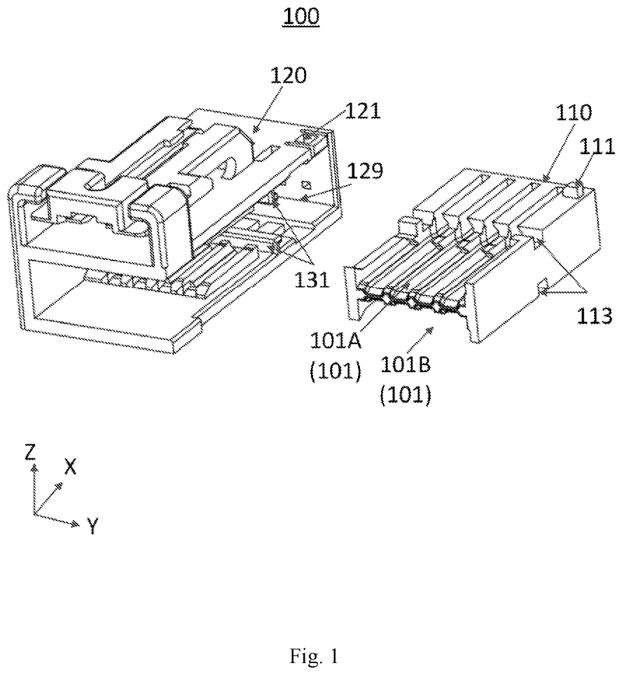

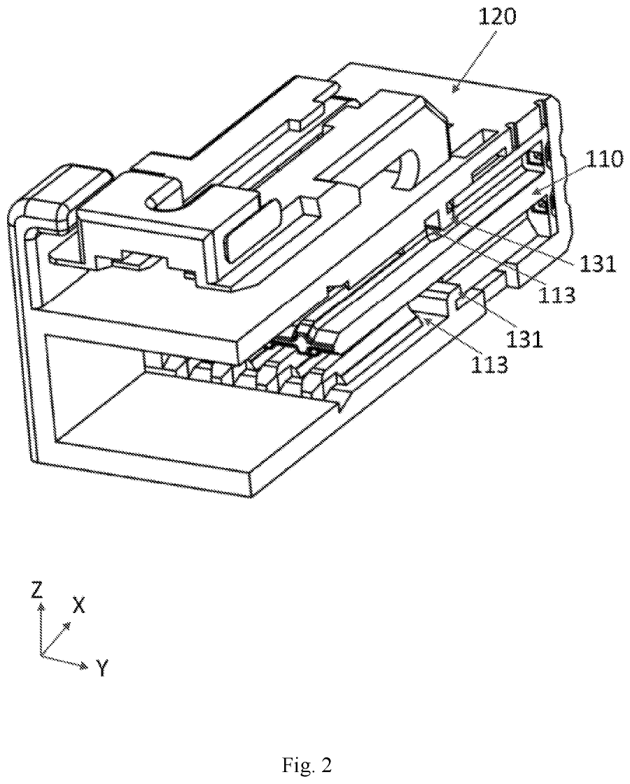

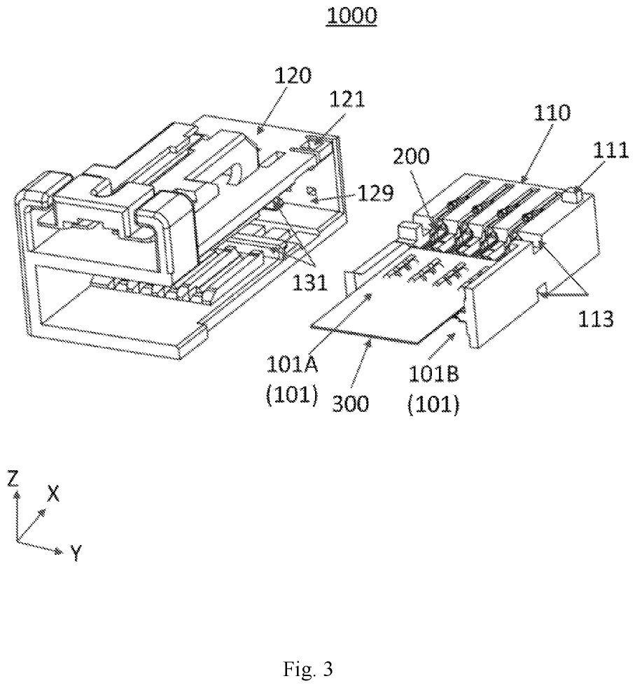

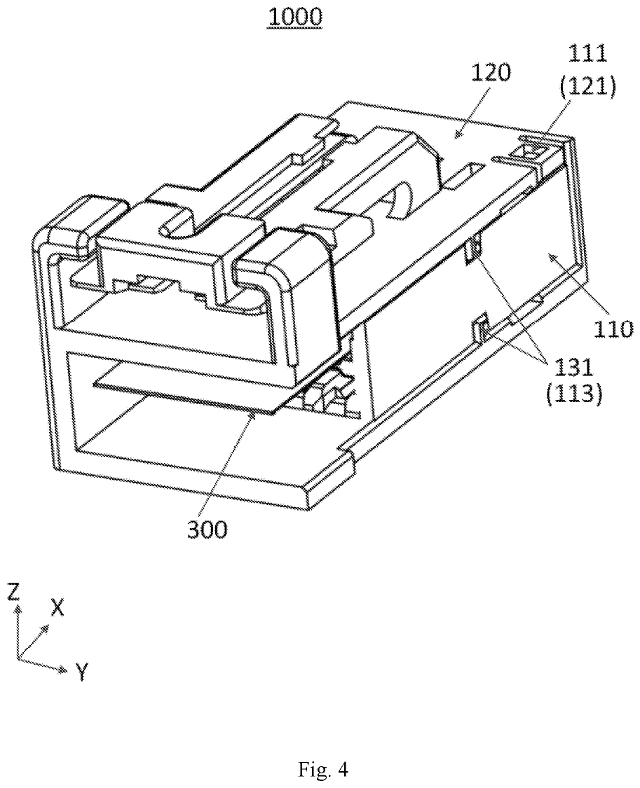

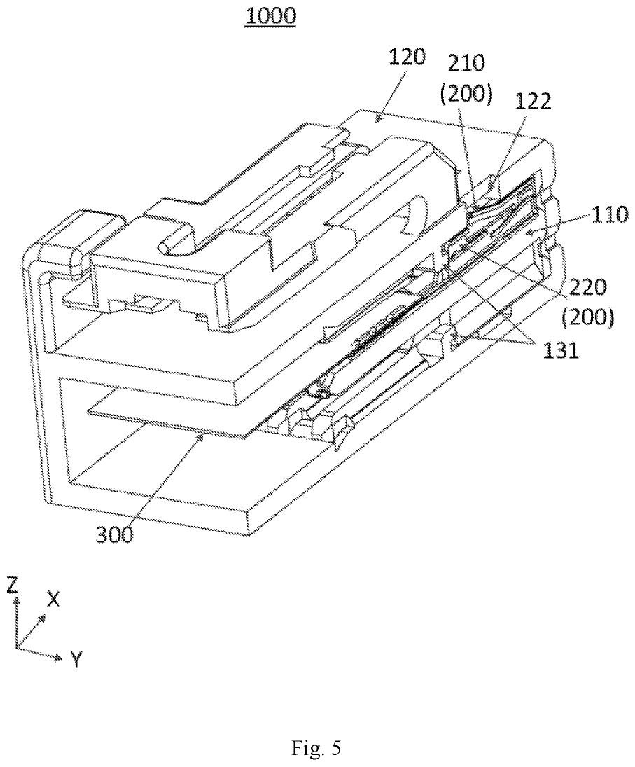

FIG. 1 is a schematic structural view showing an electrical connector housing according to an exemplary embodiment of the present disclosure, wherein a first housing part and a second housing part are separated from each other. FIG. 2 is a schematic sectional view showing the electrical connector housing according to the exemplary embodiment of the present disclosure, wherein the first housing part and the second housing part are assembled together. FIG. 3 is a schematic structural view showing the electrical connector according to an exemplary embodiment of the present disclosure, wherein the first housing part and the second housing part of the electrical connector housing are separated from each other, and connection terminals and a circuit board have been placed into a receiving slot. FIG. 4 is a schematic structural view showing the electrical connector according to the exemplary embodiment of the present disclosure, wherein the first housing part and the second housing part of the electrical connector housing are assembled together, and the connection terminals and the circuit board has been locked in the receiving slot. FIG. 5 is a schematic sectional view of the electrical connector shown in FIG. 4.

In the description of exemplary embodiments shown in FIGS. 1-5 herein, for ease of explanation and illustration, a longitudinal extension direction of a single connection terminal 200 placed into an electrical connector housing 100 is defined as a first direction X, a direction along which a plurality of connection terminals 200 are arranged side by side is defined as a second direction Y, and a direction perpendicular to both the first direction X and the second direction Y is defined as a third direction Z.

Referring to FIGS. 1 and 2, according to an embodiment of the present disclosure, the electrical connector housing 100 includes: a first housing part 110 and a second housing part 120 independent of the first housing part 110. At least one (for example, the first housing part 110 in the embodiment shown in FIG. 1) of the first housing part 110 or the second housing part 120 defines a receiving slot 101 for receiving a plurality of connection terminals 200 (see FIGS. 3-5) and a circuit board 300 (see FIGS. 3-5). The first housing part 110 and the second housing part 120 are assembled together in a manner of sliding toward each other.

Specifically, according to exemplary embodiments of the present disclosure, as shown in FIGS. 1 and 2, one side of the second housing part 120 is formed with a side opening 129. The first housing part 110 is configured to slide into the second housing part 120 from the side opening 129 of the second housing part 120. With this configuration, the first housing part 110 and the second housing part 120 may be assembled together in a sliding manner toward each other. More specifically, the first housing part 110 is formed with a sliding guide slot 113, and the second housing part 120 is formed with a sliding guide bar 131. The sliding guide bar 131 is adapted to slide along the sliding guide groove 113 to guide the sliding of the first housing part 110 into the second housing part 120.

According to the embodiments of the present disclosure, the electrical connector housing 100 adopts a split design in which the first housing part 110 and the second housing part 120 are independent of each other to expose the receiving slot 101, for example, as shown in FIG. 1, when the first housing part 110 and the second housing part 120 are not assembled together. An assembly including the connection terminals 200 and the circuit board 300 (the “assembly” described herein may refer to an integral part formed after the connection terminals 200 and the circuit board 300 are previously connected together by soldering, etc.) can be easily placed into the receiving slot 101. Specifically, the connection terminals 200 or the circuit board 300, or the assembly of the connection terminals 200 and the flexible circuit board 300 can easily be placed into the receiving slot 101 of the electrical connector housing 100 with application of only a small external force or even no external force. This fundamentally overcoming various defects caused by the insertion method of the assembly adopted in the related art.

Furthermore, as shown in FIGS. 1 and 2, the first housing part 110 is provided with a first engagement portion 111, and the second housing part 120 is provided with a second engagement portion 121. The first engagement portion 111 and the second engagement portion 121 are configured to be engaged with each other when the first housing part 110 and the second housing part 120 are assembled together, so that the receiving slot 101 is kept closed. The “closed” described herein may refer to the restoration of the electrical connector housing 100, along with the receiving slot 101 therein, to the same conventional state as the integrated housing and pocket thereof in the related art.

Specifically, in the exemplary embodiments shown in FIGS. 1 and 2, the first engagement portion 111 and the second engagement portion 121 are engaged in a snap-fit manner, wherein one (in the exemplary embodiment illustrated, the first engagement portion 111) of the first engagement portion 111 or the second engagement portion 121 is a protruding block, and the other (in the illustrated exemplary embodiment, the second engagement portion 121) of the first engagement portion 111 or the second engagement portion 121 is an elastic sheet with an opening being capable of accommodating the protruding block. In other embodiments of the present disclosure, the first engagement portion 111 and the second engagement portion 121 may be engaged in any other suitable manner of fastening fit (for example, one of the first engagement portion 111 and the second engagement portion 121 is an insert, and the other of the first engagement portion 111 and the second engagement portion 121 has a hole capable of accommodating the insert), as long as the receiving slot 101 may be kept closed when the first housing part and the second housing part are assembled together. With this configuration, it is beneficial to firmly keep the receiving slot 101 closed when the first housing part and the second housing part are assembled together.

It should be noted that according to the present disclosure, the sliding guide bar 131 is further configured to abut against the connection terminal 200 placed into the receiving slot 101 when the receiving slot 101 is kept closed. Specifically, referring to FIGS. 1 and 2, as well as FIGS. 3 and 5, it can be seen that the sliding guide bar 131 is formed on an inner surface of the second housing part 120 of the electrical connector housing 100. For example, as shown in FIG. 1, the sliding guide bar 131 is formed on the inner surface of the second housing part 120 along the second direction Y. During the second housing part 120 and the first housing part 110 are assembled together in a manner of sliding toward each other, the sliding guide bar 131 moves along the sliding guide groove 113. As a result, when the second housing part 120 and the first housing part 110 are assembled together, i.e., when the receiving slot 101 is kept closed, an end face of a crimping portion 220 of the connection terminal 200 abuts against the sliding guide bar 131 of the second housing part 120. This effectively locks the assembly of the connection terminal 200 and the circuit board 300 in an appropriate position within the receiving slot 101.

Furthermore, the second housing part 120 is formed with a locking notch 122, and the locking notch 122 is adapted to allow the connection terminal 200 placed into the receiving slot 101 to extend thereinto and to abut against the connection terminal 200 when the receiving slot 101 is kept closed. For example, according to an exemplary embodiments of the present disclosure, as shown in FIG. 5, the locking notch 122 is configured to allow an elastic sheet portion 210 of the connection terminal 200 placed into the receiving slot 101 to extend thereinto and to abut against the elastic sheet portion 210. More specifically, at least a section of the elastic sheet portion 210 of the connection terminal 200 extends into the locking notch 112, and an end of the elastic sheet portion 210 abuts against a wall of the locking notch 122, thereby further locking the assembly of the connection terminals 200 and the circuit board 300 in the appropriate position within the receiving slot 101. It should be noted that regarding the abovementioned locking notch 122, in the embodiments shown in the figures, the locking notch 122 may penetrate through the first housing part 110. In another embodiment not illustrated, the locking notch may be a blind hole formed in an inner surface of the first housing part 110, that is, it does not penetrate through the first housing part 110.

Specifically, according to the exemplary embodiments of the present disclosure, as shown in FIGS. 1 and 2, the first engagement portion 111 is integrally formed with the first housing part 110. The second engagement portion 121 is integrally formed with the second housing part 120. For example, preferably, the first engagement portion 111 and the first housing part 110 may be integrally formed from plastic material. The second engagement portion 121 and the second housing part 120 may also be integrally formed from plastic material.

The first housing part 110 further defines a first receiving slot 101A and a second receiving slot 101B for receiving the plurality of connection terminals 200 and the circuit board 300. The first receiving slot 101A and the second receiving slot 101B are positioned on opposite sides of the first housing part 110, respectively. For example, as shown in FIGS. 1 and 2, the first receiving slot 101A and the second receiving slot 101B are positioned on the opposite sides of the first housing part 110 along the third direction Z. With this configuration, the electrical connector housing provided by the embodiments of the present disclosure may receive two assemblies of the connection terminals 200 and the circuit board 300.

Therefore, with the electrical connector housing provided by the embodiments of the present disclosure, when the first housing part and the second housing part are assembled together, the electrical connector housing can effectively and accurately lock the assembly of the connection terminals and the circuit board in the receiving slot of the electrical connector housing. At the same time, accurate alignment between the connecting terminals and the through holes of the housing can be ensured. Moreover, the assembly of the connection terminals and the flexible circuit board is placed and locked in the electrical connector housing. This prevents damage to the adhesive dispensing of the crimping portion of the connection terminal. Therefore, the tolerance for the adhesive dispensing of the crimping portion of the connection terminals is improved, the thickness requirement is no longer strict, and the overall pressure resistance of the electrical connector is significantly improved.

According to the embodiments of the present disclosure, an electrical connector is also provided. Referring to FIGS. 3-5, the electrical connector 1000 includes the electrical connector housing 100 according to any one of the aforementioned embodiments, a plurality of connection terminals 200, and a circuit board 300. The plurality of connection terminals 200 and the circuit board 300 are connected together and placed into the receiving slot 101 of the electrical connector housing 100.

According to the exemplary embodiments of the present disclosure, as shown in FIG. 2, before the installation or assembling process of the electrical connector, the second housing part 120 and the first housing part 110 are not assembled together, and the receiving slot 101 of the electrical connector housing 100 is exposed, the assembly of the connection terminals 200 and the circuit board 300 can be easily placed into the receiving slot 101. During or after the installation or assembling process of the electrical connector, in the exemplary embodiments shown in FIGS. 3-5, the plurality of connection terminals 200 are arranged side by side in the electrical connector housing 100 along the second direction Y, and more specifically, arranged side by side in the second housing part 120.

According to the exemplary embodiments of the present disclosure, as shown in FIGS. 3-5, each connection terminal 200 may include a crimping portion 220. The second housing part 120 of the electrical connector housing 100 is formed with a sliding guide bar 131. The crimping portion 220 abuts against the sliding guide bar 131 when the receiving slot 101 is kept closed. For example, as shown in FIG. 4, after the installation or assembling of the electrical connector is completed, the receiving slot 101 is kept closed, and an end face of the crimping portion 220 of the connection terminal 200 abuts against the sliding guide bar 131. This effectively locks the assembly of the connection terminals 200 and the circuit board 300 in an appropriate position within the receiving slot 101.

Each connection terminal 200 may further include an elastic sheet portion 210. The second housing part 120 of the electrical connector housing 100 is formed with a locking notch 122. For example, as shown in FIG. 5, after the installation or assembling of the electrical connector is completed, the receiving slot 101 is kept closed. At least a section of the elastic sheet portion 210 of the connection terminal 200 extends into the locking notch 112, and an end of the elastic sheet portion 210 abuts against the locking notch 112. This further locks the assembly of the connection terminals 200 and the circuit board 300 in the appropriate position within the receiving slot 101.

Therefore, with the electrical connector provided by the embodiments of the present disclosure, after the installation or assembling of the electrical connector is completed, the receiving slot of the electrical connector housing is kept closed, and the assembly of the connection terminals 200 and the circuit board 300 can be effectively locked in the receiving slot of the electrical connector housing. Further, the plurality of connection terminals 200 are configured to be engaged with the circuit board 300 in a crimping manner. The circuit board 300 described herein is preferably a flexible printed circuit board.

In this way, with the electrical connector provided by the embodiments of the present disclosure, the assembly of the connection terminals and the flexible printed circuit board is placed and locked in the electrical connector housing, damage to the adhesive dispensing of the crimping portion of the connecting terminal is prevented. As a result, the tolerance for the adhesive dispensing of the crimping portion of the connection terminal is improved, the thickness requirement is no longer strict, and the overall pressure resistance of the electrical connector is significantly improved.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connector housing, comprising:
a first housing part; and
a second housing part independent of the first housing part, at least one of the first housing part or the second housing part defines a receiving slot sized to receive a plurality of connection terminals and a circuit board, the first housing part and the second housing part are adapted to be slidably assembled together.

2. The electrical connector housing according to claim 1, wherein one side of the second housing part is formed with a side opening, and the first housing part is adapted to slide into the second housing part from the side opening of the second housing part.

3. The electrical connector housing according to claim 2, wherein:
the first housing part is formed with a sliding guide slot; and
the second housing part is formed with a sliding guide bar, the sliding guide bar adapted to slide along the sliding guide slot and guide the sliding of the first housing part into the second housing part.

4. The electrical connector housing according to claim 3, wherein the sliding guide bar is further adapted to abut against the connection terminal placed into the receiving slot when the first housing part is received into the second housing part.

5. The electrical connector housing according to claim 1, wherein the second housing part includes a locking notch adapted to permit the connection terminal placed into the receiving slot to extend thereinto, and to abut against the connection terminal when the receiving slot is kept closed by the first housing part and the second housing part being assembled together.

6. The electrical connector housing according to claim 1, wherein:
the first housing part is provided with a first engagement portion;
the second housing part is provided with a second engagement portion; and
the first engagement portion and the second engagement portion are adapted to engage with each other when the first housing part and the second housing part are assembled together such that the receiving slot is kept closed.

7. The electrical connector housing according to claim 6, wherein the first engagement portion and the second engagement portion engage in a snap-fit manner.

8. The electrical connector housing according to claim 7, wherein one of the first engagement portion or the second engagement portion is a protruding block, and the other of the first engagement portion or the second engagement portion is an elastic sheet with an opening adapted to accommodate the protruding block.

9. The electrical connector housing according to claim 6, wherein the first engagement portion is integrally formed with the first housing part, and the second engagement portion is integrally formed with the second housing part.

10. The electrical connector housing according to claim 1, wherein the first housing part further defines a first receiving slot and a second receiving slot adapted to receive the plurality of connection terminals and the circuit board.

11. The electrical connector housing according to claim 10, wherein the first receiving slot and the second receiving slot are positioned on opposite sides of the first housing part, respectively.

12. An electrical connector, comprising:
an electrical connector housing, including:
a first housing part; and
a second housing part independent of the first housing part, at least one of the first housing part or the second housing part defines a receiving slot sized to receive a plurality of connection terminals and a circuit board, the first housing part and the second housing part are adapted to be slidably assembled together;
a plurality of connection terminals; and
a circuit board, the plurality of connection terminals and the circuit board are connected together and placed into the receiving slot of the electrical connector housing.

13. The electrical connector according to claim 12, wherein each connection terminal includes a crimping portion.

14. The electrical connector according to claim 13, wherein:
the second housing part of the electrical connector housing includes a sliding guide bar; and
the crimping portion abuts against the sliding guide bar when the first housing part and the second housing part are assembled together.

15. The electrical connector according to claim 12, wherein:
each connection terminal includes an elastic sheet portion; and
the second housing part of the electrical connector housing includes a locking notch adapted to receive the elastic sheet portion.

16. The electrical connector according to claim 15, wherein at least a section of the elastic sheet portion extends into the locking notch, and an end of the elastic sheet portion abuts against the locking notch, when the first housing part is assembled with the second housing part.

17. The electrical connector according to claim 12, wherein the plurality of connection terminals are fitted with the circuit board via crimping.

18. The electrical connector according to claim 12, wherein the circuit board is a flexible printed circuit board.

19. An electrical connector housing, comprising:
a first housing part; and
a second housing part slidably receiving the first housing part therein, at least one of the first housing part or the second housing part defines a receiving slot receiving a plurality of connection terminals and a circuit board, the second housing part is slidably received within the first housing part in a first direction transverse to a longitudinal extension direction of the plurality of connection terminals.

20. The electrical connector housing according to claim 19, wherein the first direction is parallel to a direction along which the plurality of connection terminals are arranged side by side.
